(19) United States
(12) Patent Application Publication
(10) Pub. No.: US 2021/0276663 A1
(43) Pub. Date: Sep. 9, 2021

(54) KITS TO CONVERT SINGLE-SPEED BICYCLES TO MULTI-SPEED BICYCLES

(71) Applicant: William W. Nelson, San Diego, CA (US)

(72) Inventor: William W. Nelson, San Diego, CA (US)

(21) Appl. No.: 17/190,352

(22) Filed: Mar. 2, 2021

Related U.S. Application Data
(60) Provisional application No. 62/984,746, filed on Mar. 3, 2020.

(51) Int. Cl. B62M 9/135; B62M 9/16

(52) U.S. Cl. CPC B62M 9/135; B62M 9/16

(57) ABSTRACT

Kits for converting a single-speed bicycle to a multi-speed bicycle are described. Such kits typically include a front chainring set having 2-5 differently-sized front chainrings, a front derailleur compatible with the front chainring set, a front derailleur shifting assembly compatible with the front derailleur, a chain tensioner, and a chain sized to accommodate the gearing provided by the plurality of front chainrings and the existing or new rear sprocket(s) to be fitted to the rear wheel of the bicycle undergoing the conversion.

### RELATED APPLICATION

This application is related to, and claims the benefit of and priority to, U.S. non-provisional patent application No. 62/984,746, filed 3 Mar. 2020, which is hereby incorporated by reference in its entirety for any and all purposes.

### TECHNICAL FIELD OF THE INVENTION

This invention is directed to bicycles, particularly to converting single-speed bicycles to multi-speed bicycles by replacing the single front chainring with a plurality of front chainrings that a user can select from among by shifting.

### BACKGROUND OF THE INVENTION

### 1. Introduction

The following description includes information that may be useful in understanding the present invention. It is not an admission that any such information is prior art, or relevant, to the presently claimed inventions, or that any publication specifically or implicitly referenced is prior art.

### 2. Background

Bicycles are popular, ecologically friendly, health-promoting modes of transportation. Many bicycles include one or more transmission devices that allow a bicycle rider (cyclist) to select between multiple gears. Such transmission devices can include a rear derailleur device that includes both a gear-changing device and a chain-tensioning device incorporated together as a unit. The rear derailleur is used to shift from one gear in a cluster of different gears (a rear cluster) to another gear by guiding the bicycle's drive chain to engage with a particular sprocket from among a plurality of sprockets in the rear cluster attached to a freehub or freewheel, each of which sprockets provides a different mechanical advantage between an input from a rider to the bicycle's pedals and an output to the bicycle's rear wheel. Some bicycles also include both front and rear derailleurs. On such bicycles, a cyclist uses the front derailleur to switch between a plurality of different front chainrings each having a different size (i.e., number of teeth), each of which also provides a different mechanical advantage. Today, bicycles having rear clusters with as many as 12 different gears are available, as are bicycles with 2-3 front chainrings. Even with the widespread availability of multi-speed bicycles, however, a large number of single-speed bicycles are still produced each year, and many older single-speed bicycles are still in use, although their utility is limited by the absence of readily changeable gearing.

### 3. Definitions

Before describing the instant invention in detail, several terms used in the context of the present invention will be defined. In addition to these terms, others are defined elsewhere in the specification, as necessary. Unless otherwise expressly defined herein, terms of art used in this specification will have their art-recognized meanings.

As used herein, the singular forms “a”, “an”, and “the” include plural references unless the context clearly dictates otherwise.

As used herein, the term “about” refers to approximately a +/−10% variation from the stated value. It is to be understood that such a variation is always included in any given value provided herein, whether or not it is specifically referred to.

A “chainring” refers to a ring or gear having teeth for engaging a compatible bicycle chain. A chainring can be single component or be made from multiple components, such as a chainring, a spider, and bolts (or other fasteners) to secure the various components together. A front chainring refers to a chainring connected (directly or indirectly) to bicycle's crankset. A “front chainring set” refers to a plurality of differently-sized front chainrings assembled as a set.

A “chain tensioner” refers to a spring-loaded device that includes at least one pulley and whose primary (or sole) function is to maintain chain tension as the chain is moved between front chainrings of different sizes. As will be appreciated, when a cyclist selects a different front chainring from the front chainring then in use, the chain will slacken. If the slack in the chain is not taken up, the chain may disengage from the front chainring and/or rear sprocket, or tighten (as would occur when shifting into a larger front chainring) due to the diameter difference from one front chainring to another. Thus, the chain tensioner can account for these phenomena and maintain appropriate chain tension as shifting occurs.

A “derailleur” refers to a device for moving a chain from one sprocket to another. A “front” derailleur refers to a derailleur designed to move a bicycle chain from one front chainring to another. Shifting of a derailleur can be manual or via an electric motor integrated in the derailleur device. Power for an electric front derailleur is preferably supplied via a rechargeable battery (or battery pack).

A “one-piece crank” (or crank set) refers to a bicycle component that includes a left crank arm, a right crank arm, and a bottom bracket axle or spindle forged or otherwise constructed as a single part, or assembled from multiple parts prior to assembly with a bottom bracket of a bicycle frame. One-piece cranks usually also include a drive pin (21) designed for insertion into a drive pin hole (22) in the outermost chainring (or spider of a multi-part chainring) of the front chainring set (1).

A “patentable” composition, process, machine, or article of manufacture according to the invention means that the subject matter at issue satisfies all statutory requirements for patentability at the time the analysis is performed. For example, with regard to novelty, non-obviousness, or the like, if later investigation reveals that one or more claims encompass one or more embodiments that would negate novelty, non-obviousness, etc., the claim(s), being limited by definition to “patentable” embodiments, specifically excludes the unpatentable embodiment(s). Also, the claims appended hereto are to be interpreted both to provide the broadest reasonable scope, as well as to preserve their validity. Furthermore, if one or more of the statutory requirements for patentability are amended or if the standards change for assessing whether a particular statutory requirement for patentability is satisfied from the time this application is filed or issues as a patent to a time the validity of one or more of the appended claims is questioned, the claims are to be interpreted in a way that (1) preserves their validity and (2) provides the broadest reasonable interpretation under the circumstances.

In the context of the invention, a “multi-speed” bicycle refers to one having at least two front chainrings of different sizes, with 2-5 differently sized chainrings being preferred, wherein a cyclist uses a front derailleur to select which chainring to use at a particular time. By virtue of being able to select between front chainrings, the bicycle has at least two gear ratios, with the exact number of ratios being determined by the number of front chainrings In contrast, a “single-speed bicycle” is a bicycle having a drivetrain with a single gear ratio, which gear ratio is determined by the size of the bicycle's front chainring, and rear sprocket. A single speed bicycle can be either a fixed-gear bicycle (or “fixie”, i.e., a bicycle whose drivetrain has no freewheel or freehub mechanism) or one that has a freewheel or freehub mechanism that allows it to coast. Examples of single speed bicycles include BMX bicycles, most bicycles designed for children, and “cruiser”-type bicycles for adults.

A “plurality” means more than one.

In the context of the invention, to “retrofit”, “retrofitting”, and the like means to add to change at least one mechanical aspect or component of a bicycle such that the part(s) changed in the retrofit process alter the nature of the bicycle. For example, replacing the front chainring on a bicycle having a single front chainring to one having two or more front chainrings is a representative example of “retrofitting” the bicycle. Similarly, also adding a front derailleur and compatible front derailleur shifting assembly to such a bicycle is also an example, alone or in conjunction with changing to a front chainring set that includes 2-5 front chainrings, are further examples of “retrofitting” a bicycle in accordance with the invention.

A “used bicycle” refers to a bicycle that has been previously leased, rented, or purchased by at least one retail customer or consumer, whereas a “new” bicycle refers to a bicycle that has not been previously leased, rented, or purchased by a retail customer or consumer.

A “wheel” or “bicycle wheel” refers to a front or rear wheel assembly for a bicycle. It includes a hub (having bearings, an axle, and a hub shell configured for spoke attachment), spokes, and a rim connected to the hub via the spokes) for mounting a compatible tubed or tubeless bicycle tire. 3

### SUMMARY OF THE INVENTION

The object of the invention is to provide patentable kits that can be used to convert a single-speed bicycle, be it new or used, to a multi-speed bicycle. Thus, one aspect of the invention concerns kits for performing such conversions or retrofits. Such kits typically include a front chainring set having 2-5 differently-sized front chainrings, a front derailleur compatible with the front chainring set, a front derailleur shifting assembly compatible with the front derailleur, a chain tensioner, and a chain sized to accommodate the gearing provided by the plurality of front chainrings and the existing or new rear sprocket to be fitted to the rear wheel of the bicycle undergoing the conversion. In some embodiments, such kits can also include one, some, or all of the following: a rear sprocket; a crank assembly configured for use with the front chainring set, wherein the crank assembly comprises (i) a one-piece crank or (ii) two separate crank arms and a spindle; a front handbrake system; a rear handbrake system; pedals configured for assembly with the crank assembly; a bottom bracket; a front wheel configured for use with the front handbrake system; a rear wheel configured for use with the rear handbrake system; a front tire configured for use with the front wheel; and/or a rear tire configured for use with the rear wheel. Preferably, the kits of the invention also include written instructions, or an online link to instructions (e.g., a website or webpage address, a QR code, or the like), for assembling components of the kit with a bicycle configured to receive the components.

A related aspect of the invention relates to bicycles, often used bicycles, that have been retrofitted with the components of a kit according to the invention.

Another aspect of the invention concerns methods of converting a single-speed bicycle to a multi-speed bicycle by installing the components of a kit of the invention on a partially assembled bicycle configured t receive them. At a minimum such methods involve installing a front chainring set (preferably one having 2-5 front chainrings of different sizes), a front derailleur, a shifter that allows a rider to select from among the different front chainrings, a chain sized to accommodate the highest or tallest gearing in the bicycle's new multi-speed drive train, and a bicycle chain tensioner that sufficiently tensions the chain across the complete range of the bicycle's new multi-speed gearing.

Additional features and advantages of the invention will be apparent from the following detailed description, and appended claims.

### BRIEF DESCRIPTION OF THE DRAWINGS

These and other aspects will now be described in detail with reference to the following drawings. Unless otherwise indicated, it is understood that the drawings are not to scale, as they are intended merely to facilitate understanding of the invention as opposed to specific dimensions, etc. In the drawings, like numbers in two or more drawings represent like elements.

FIG. 1 shows a conventional single-speed bicycle.

FIG. 2 shows a bicycle having a kit according to the invention (a new bicycle or a used one retrofit with a kit of the invention) installed thereon, including front chainring set (1) having three chainrings, a front derailleur (3) for selecting a front chainring from among the plurality of front chainrings in the front chainring set, a shifter (12) that a rider can use to select a desired front chainring from among the plurality of front chainrings in the front chainring set, a chain tensioner (2), and a front handbrake assembly (11), which includes a front brake lever assembly attached to the handlebars (13), a front brake caliper (here, for a front rim brake), and a cable spanning from the front brake lever assembly to the front caliper that allows a rider to apply brake pressure to the front wheel by squeezing the front brake lever. As will be appreciated, the bicycle, and kit of the invention, could also include a rear handbrake assembly (not shown), which would include a brake lever assembly also attached to the handlebars, a rear brake caliper (here, for a rear rim brake), and a cable spanning from the rear brake lever assembly to the rear caliper that allows a rider to apply brake pressure to the rear wheel by squeezing the rear brake lever.

FIG. 3 highlights the single piece crank set (10) and single front chainring (7) of the bicycle shown in FIG. 1.

FIG. 4 shows a representative 3-ring front chainring set useful in accordance with the invention. In some other embodiments, the front chainring set could have 2, 4, or 5 chainrings.

FIG. 5 focuses on an embodiment of a bicycle retrofitted with a kit of the invention to have a front chainring set with 3 front chainrings (1a, 1b, 1c), one rear sprocket (5), a chain tensioner (2), a chain (4), a front derailleur (3), and two crank arms (6) (axle not shown).

FIG. 6 shows a rear brake arm (9) of a single-speed bicycle that, once retrofitted with a kit of the invention to include a multi-ring front chainring set and chain tensioner, no longer serves a purpose.

FIG. 7 shows a conventional front chainring (7) with only one chainring (7) with 2 crank arms (6) joined by an axle (8).

FIG. 8 shows a front chainring set (1) with three differently-sized chainrings (1a, 1b, 1c) joined to two crank arms (6) joined by an axle (8).

The details of one or more embodiments are set forth in the accompanying drawings and the description below. Other features and advantages will be apparent from the description and drawings, and from the claims.

### DETAILED DESCRIPTION

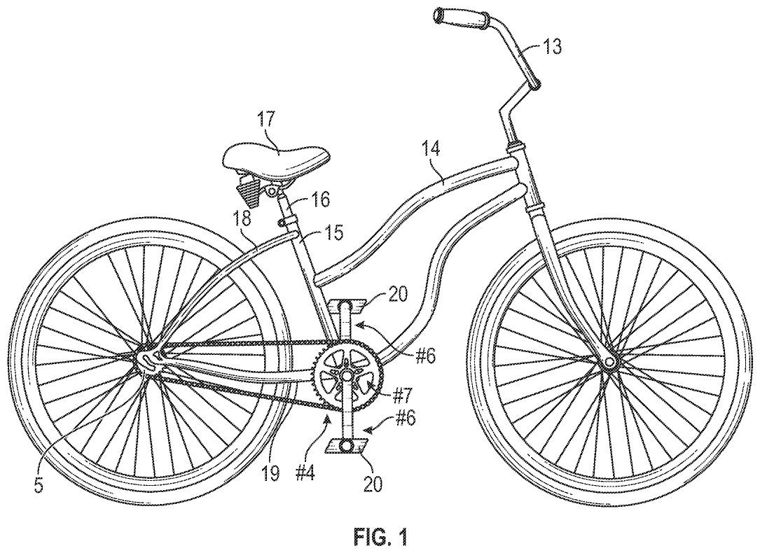

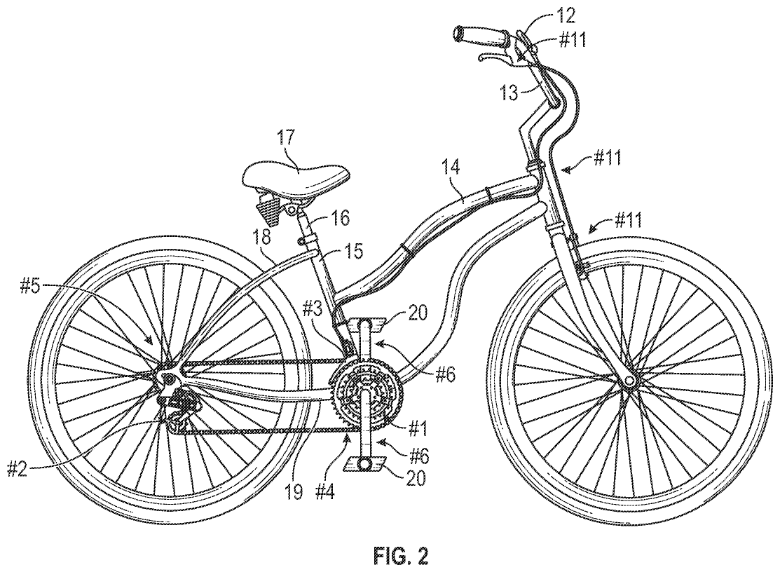

In the following detailed description, reference is made to the accompanying drawings, labeled as FIGS. 1-8. FIGS. 1, 3, and 6 show a conventional single-speed bicycle and certain components thereof. FIGS. 2, 4, 5, 7, and 8 illustrate certain preferred, representative components and embodiments of the invention, a more detailed description of which follows.

The present invention concerns patentable kits that can be used to convert a used, single-speed (having a drive train with but one gear ratio) bicycle to a multi-speed (having multiple gear ratios) bicycle. This is accomplished by replacing the single front chainring of a single-speed bicycle with a front chainring set that has multiple chainrings (e.g., 2-5, preferably 2 or 3, front chainrings of different size to provide, for example, a 2- or 3-speed bicycle (or bicycle having, for example, 2 or 3 different gear ratios that a rider can choose from).

A representative single-speed bicycle suitable for such a conversion is illustrated in FIG. 1. It includes a bicycle frame that includes a top tube (14), a seat tube (15), a seat post (16), a seat (or saddle, 17), seat stays (18), chain stays (19), handlebars (13), and a drive train that includes a single front chainring (7), a single-piece crank with two crank arms (6), pedals (20) attached to the crank arms, a chain (4), a rear wheel having a rear sprocket (5) and tire, and a front wheel and tire.

As will be understood, a conventional bicycle can be converted to a multi-speed bicycle using a kit according to the invention. Such kits will typically include a front chainring set having 2-5 differently-sized front chainrings. In a front chainring set, the chainrings are concentric, rotate together as a single, integrated unit, can be independently selected by a rider using a handlebar- or frame-mounted shifter to actuate (electronically or mechanically) a front derailleur securely attached or mounted (e.g., via brazing, clamping, bolting, etc.) to the frame's seat tube (15) proximate to the location where the bicycle's chain begins to engage whichever front chainring in the front chainring set is then selected. The front chainring set can be assembled from separate individual chainrings of different size (i.e., having different numbers of teeth) or be formed from a single piece of material. Individual chainrings can be single pieces or made from multiple components, for example, an outer chainring having teeth to engage a bicycle chain connected (e.g., by bolts or other fasteners) to a spider or central portion.

The kits of the invention will also include a front derailleur compatible with the front chainring set, a front derailleur shifting assembly compatible with the front derailleur, a chain tensioner, and a chain sized to accommodate the gearing provided by the plurality of front chainrings and the existing or new rear sprocket to be fitted to the rear wheel of the bicycle undergoing the conversion. The front derailleur is configured for attachment to a bicycle frame using a clamp, bracket, brazing, or another suitable approach. The front derailleur can be a mechanical or electro-mechanical. A mechanical front derailleur uses a cable connected to the shifter to move the derailleur when a cyclist selects a gear change (i.e., in the context of the invention, a change from one front chainring to another). For mechanical shifting, shifting includes index shifting, whereby the shifter is designed to move the cable that connects the shifter assembly to the front derailleur moves the cable in small, pre-determined increments. Mechanical shifting also includes friction shifting, which differs from index shifting, in that the rider uses to shifter to move the derailleur (typically via a wire cable attached at one end to the shifter and at the other end to the derailleur) between in a linear manner, without pre-determined increments. For an electro-mechanical, index shifting-based front derailleur, a small electric motor (connected to a rechargeable battery) moves the derailleur a pre-determined amount following receipt of a shift command at the shifter unit. Electronic shifting can be wireless or wired.

A chain tensioner is also an important component of kits of the invention, as it allows proper chain tension to be maintained during shifting, pedaling, and coasting (provided the rear hub provides free-wheeling capability), regardless of which front chainring is then selected. The chain tensioner can be attached to a rear hanger, if present on the bicycle frame, or it can be attached via the rear axle and rear axle bolt. Alternatively, the chain tensioner can be attached to the chain stay on the same side of bicycle as the rear sprocket and front chainring set. Any suitable attachment configuration can be employed. In some embodiments, the hanger for the chain tensioner is a separate, intermediate part that allows the chain tensioner to be attached at the rear of the bicycle, preferably via the rear axle and axle nut.

Preferably, the kits of the invention will also include a crank assembly configured for use with the new front chainring set, be it a one-piece crank or two crank arms and a spindle. In certain preferred embodiments, such kits can also include a rear sprocket, a front handbrake system, a rear handbrake system, pedals configured for assembly with the crank assembly, and/or a bottom bracket. The kit may also include a front wheel configured for use with the front handbrake system, a rear wheel configured for use with the rear handbrake system, and, if desired front and/or rear tires configured for use with the front and/or rear wheel. Preferably, the kits of the invention also include written instructions, or an online link to instructions (e.g., a website or webpage address, a QR code, or the like), for assembling components of the kit with a bicycle configured to receive the components.

As those in the art will appreciate, while many kit embodiments of the invention include a new crank assembly configured for use with the new front chainring set, a new crank assembly may not be required when the kit's front chainring set is compatible with the crank assembly from the original bicycle undergoing single- to multi-speed conversion. In such embodiments, the new front chainring set will replace the original (or existing) single front chainring and will be assembled with the existing crank assembly.

In many embodiments, the single rear cog from the bicycle being converted from a single-speed to a multi-speed bicycle is retained, although in many preferred embodiments the original rear sprocket is replaced with a new one, which may be of the same or different size (i.e., have the same or a different diameter and the same or different number of teeth).

With regard to kits that include one or both of a front and/or rear handbrake system, such systems will typically include a brake lever, a cable for transmitting braking force, and a brake caliper, for example, a rim brake caliper. Mounting hardware for the brake system components is also preferably included.

A chain tensioner is also added at the rear near the rear sprocket (or along the frame's chain stay on the same side as the chain) to maintain chain tension regardless of which of the different front chainrings is selected at the particular time. Because a chain tensioner, however, only maintains chain tension with forward pedaling, its use renders any rear coaster brake non-functional. Due to the new multi-speed gearing, the kits of the invention also usually include a new chain, sized to accommodate the highest gearing (using the largest of the front chainrings), although if the largest front chainring of the front chainring set is the same size as the single-speed front chainring being replaced, then a new chain may not be essential. And because many single-speed bicycles amendable to conversion and/or retrofitting in accordance with the invention lose coaster brake function, in many embodiments a new front and/or rear handbrake system (i.e., handlebar-mounted handbrake housing and lever, cabling, brake caliper, and brake pads) is included in the kit and mounted to the bicycle as part of the conversion process.

A single-speed bicycle converted to a multi-speed bicycle using a kit according to the invention is illustrated in FIG. 2. Such a single-speed bicycle can initially be a bicycle as shown in FIG. 1, for example, and after conversion using a kit of the invention, it becomes a multi-speed bicycle that includes at least a front chainring set (1) in place of the original single front chainring, a newly added front derailleur (3) mounted to the frame's seat tube (15), a newly added chain tensioner (2), and newly added a shifter (12) for selecting among the different chainrings in the new front chainring set (1). In the embodiment shown in FIG. 2, the new front derailleur (3) is mechanically actuated via a cable running between the front derailleur (3) and the new handlebar-mounted shifter (12). In this embodiment, the chain tensioner (2) includes a hanger used to hang the tensioner from the rear axle and which is secured using a rear axle bolt. As will be appreciated, the kit of the invention used to perform a conversion as shown in FIG. 2 (and many if not all kits of the invention, for that matter) also preferably includes all of the accessories, fasteners (e.g., bolts, nuts, cable or zip ties, etc.), and peripherals needed to install the kit's components on the bicycle. The tools required to perform a conversion according to the invention are typically not included in the kit, although the invention envisions kits that also include one or more of the tools helpful or necessary to perform the conversion. Instructions for installing such a kit (or any kit of the invention) are also preferably included with the other kit components, although in some embodiments some or all of the instructions are provided online. Online instructions can be accessed in suitable manner, including by scanning a QR code or by entry of a website address into a web browser that directs the user to a website hosting the instructions.

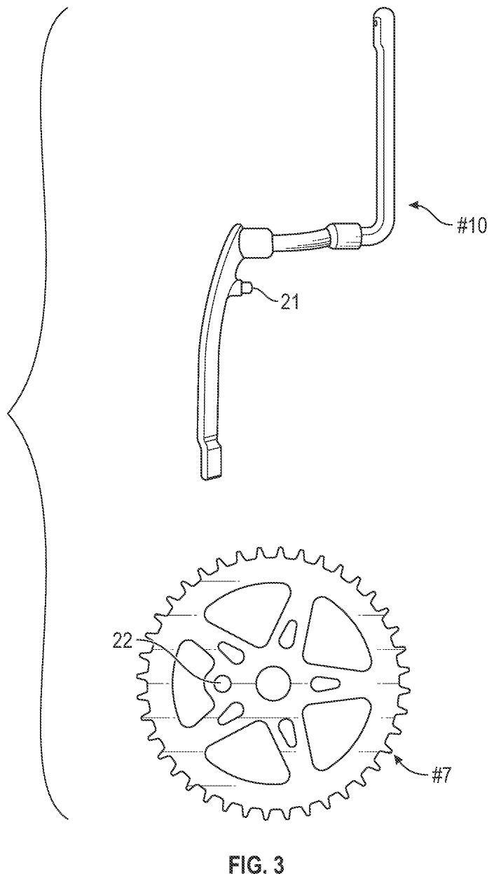

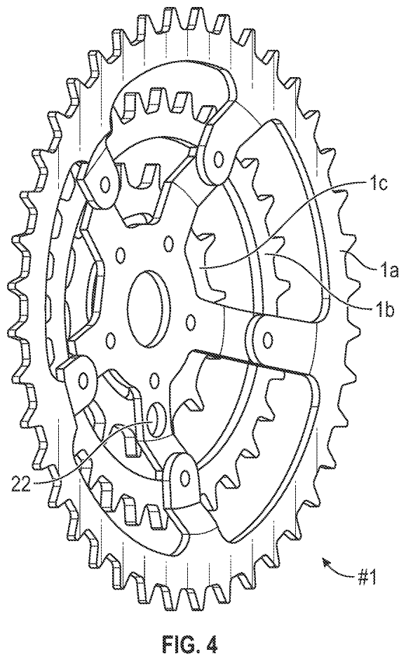

FIG. 3 illustrates a conventional single piece crank set (10) and single front chainring (7) of a conventional single-speed bicycle, such as is shown, for example, in FIG. 1. In such embodiments, single piece crank set (10) has two crank arms (6) and a drive pin (21) configured to engage a drive pin hole (22) in the front chainring (7). FIG. 4 shows a representative front chainring set (1) that has three front chainrings (1a, 1b, 1c), each of different size and each of which therefore provides a different gear ratio when combined the rear sprocket. The front chainring set (1) also has a drive pin hole (22), making it compatible with a conventional single piece crank set (10) having a corresponding drive pin (21) or a new single piece or dual crank arm/spindle crank assembly.

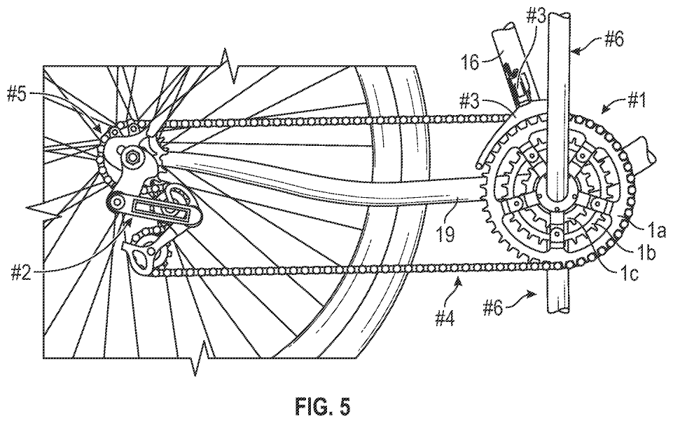

FIG. 5 shows an embodiment of a drive train of a bicycle retrofitted in accordance with the invention. In this embodiment, the kit provides a front chainring set having 3 front chainrings (1a, 1b, 1c), a chain tensioner (2), a chain (4), a front derailleur (3), and a crank assembly having two crank arms (6). The bicycle also has one rear sprocket (5), which may be included as part of the kit or provided separately; for example, the rear sprocket may be the bicycle's original rear sprocket or it may have been purchased separately from the kit.

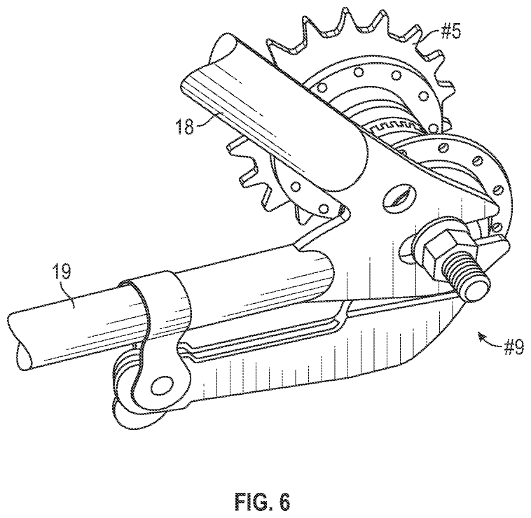

FIG. 6 shows a rear brake arm (9) of a single-speed bicycle that, once retrofitted with a kit of the invention to include a multi-ring front chainring set, chain tensioner, and new chain, no longer serves a purpose. As a result, the bicycle is preferably also retrofit with at least one handbrake assembly, preferably both a front and rear handbrake assembly, which may be included in the kit of the invention or be purchased or otherwise acquired separately.

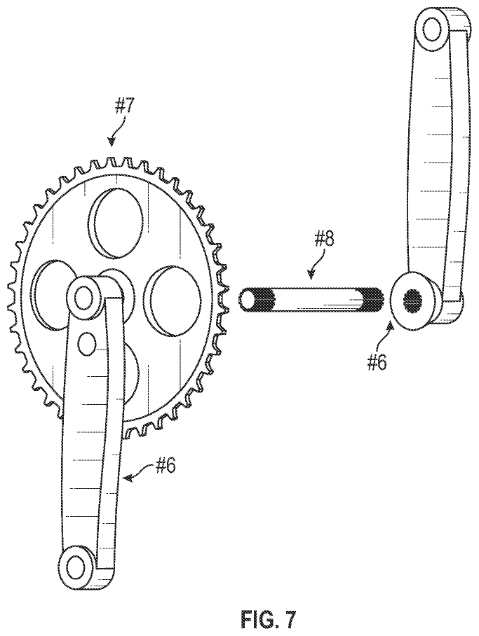

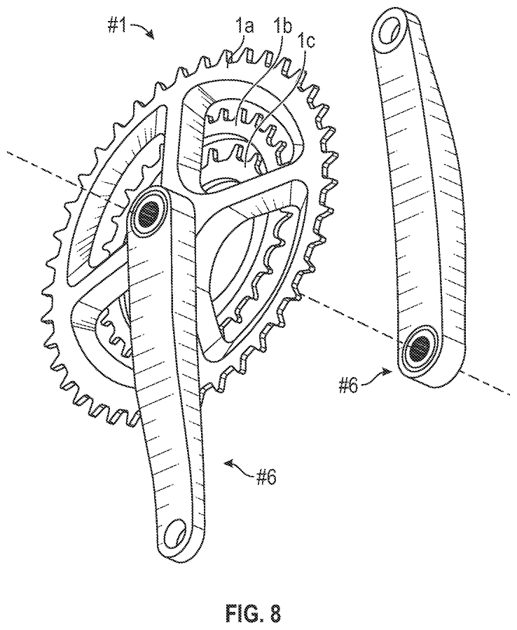

FIGS. 7 and 8 show a conventional front chainring (7) with only one chainring (7) with 2 crank arms (6) joined by an axle (8) and a representative front chainring set (1) with three differently-sized chainrings (1a, 1b, 1c) joined to two crank arms (6) joined by an axle (8). Such a front chainring set provides the bicycle with three different gear ratios.

Unless the context clearly requires otherwise, throughout the description above and the appended claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list, and any combination of the items in the list.

The foregoing description, for purpose of explanation, has been described with reference to specific embodiments. However, the illustrative discussions above are not intended to be exhaustive or to limit the invention to the precise forms disclosed. Many modifications and variations are possible in view of the above descriptions. The embodiments were chosen and described in order to best explain the principles of the invention and its practical applications to thereby enable others skilled in the art to best utilize the invention and various embodiments with various modifications as are suited to the particular use contemplated. As such, the invention extends to all functionally equivalent structures, methods, and uses, such as are within the scope of the appended claims, and it is intended that the invention be limited only to the extent required by the applicable rules of law.

1. A kit to convert a used, single-speed bicycle to a multi-speed bicycle, the kit comprising:
a. a front chainring set that comprises 2-5 front chainrings, each of a different size or tooth count;
b. a front derailleur compatible with the front chainring set;
c. a front derailleur shifting assembly compatible with the front derailleur;
d. a chain tensioner; and
e. a chain sized to span gearing from the largest front chainring to the smallest front chainring when included in a bicycle drive train that includes the front chainring set, the chain tensioner, and a rear sprocket attached to a rear bicycle wheel mounted on a bicycle.

2. A kit according to claim 1 that further comprises one, some, or all of the following:
a. a rear sprocket;
b. a crank assembly configured for use with the front chainring set, wherein the crank assembly comprises (i) a one-piece crank or (ii) two crank arms and a spindle;
c. a front handbrake system;
d. a rear handbrake system;
e. pedals configured for assembly with the crank assembly; and/or
f. a bottom bracket.

3. A kit according to claim 2 that further comprises one, some, or all of the following:
a. a front wheel configured for use with the front handbrake system;
b. a rear wheel configured for use with the rear handbrake system;
c. a front tire configured for use with the front wheel; and/or
d. a rear tire configured for use with the rear wheel.

4. A kit according to claim 1 that further comprises instructions, or an online link to instructions, for assembling components of the kit with a bicycle, optionally a used bicycle, configured to receive the components.

5. A used bicycle retrofit with a kit according to claim_1.
